(19) United States
(12) Patent Application Publication
(10) Pub. No.: US 2008/0277187 A1
(43) Pub. Date: Nov. 13, 2008

(54) Power steering apparatus

(75) Inventors: Daniel E. Williams, Lebanon, IN (US); Robert Ducharme, Lafayette, IN (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/801,949

(22) Filed: May 11, 2007

(51) Int. Cl. B62D 5/06; B62D 5/22

(52) U.S. Cl. 180/422; 180/421; 180/428

(57) ABSTRACT

An engine driven pump 24 is connected with a power steering motor assembly 18. An electric motor 36 drives a pump 34 connected with the power steering motor assembly 18. A controller 38 effects operation of the electric motor 36 to drive the pump 34 to supply fluid to the power steering motor assembly 18 at a flow rate based on the speed of the engine 28.

### BACKGROUND OF THE INVENTION

The present invention is directed to an apparatus for use in turning steerable vehicle wheels.

In a conventional power steering system, an engine driven pump outputs a fixed volume of fluid per engine revolution. Thus, the flow rate of the pump is proportional to the engine speed. The pump is sized to provide the necessary flow so that an operator can easily steer the vehicle when the engine is idling or at very low speeds.

A conventional open center hydraulic power steering system generally requires that the flow rate of hydraulic fluid be the same at all engine speeds. To ensure a constant flow rate from the pump, a control valve is included at the output of the pump to control the fluid flow from the pump.

An electric motor driven pump unit can be used instead of the engine driven pump. However, the electric motor driven pump unit requires a conversion from mechanical to electric power in the vehicle generator and another conversion from electrical to mechanical power in the motor driven pump unit.

### SUMMARY OF THE INVENTION

The present invention relates to an apparatus for use in turning steerable vehicle wheels. The apparatus comprises a power steering motor assembly connected with the steerable vehicle wheels. A first pump is connected with the power steering motor assembly and is driven by an engine of the vehicle to supply fluid under pressure to the power steering motor assembly. A second pump is connected with the power steering motor assembly to supply fluid under pressure to the power steering motor assembly at a flow rate that increases as the speed of the engine decreases.

In a second aspect of the present invention also relates to an apparatus for use in turning steerable vehicle wheels includes a power steering motor assembly which is connected with the steerable vehicle wheels. A first pump is connected with the power steering motor assembly. The first pump is driven by an engine of the vehicle to supply fluid under pressure to the power steering motor assembly. A second pump is connected with the power steering motor assembly. An electric motor is operable to drive the second pump to supply fluid under pressure to the power steering motor assembly. A controller operatively connected with the engine and operatively connected to the electric motor of the second pump effects operation of the electric motor to drive the second pump to supply fluid at a flow rate based on the speed of the engine.

It should be understood that the present invention has many different features. These features may be combined in the manner disclosed herein. Alternatively, the features may be utilized separately from each other or in various combinations with each other and with features from the prior art.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic illustration of a power steering apparatus constructed and operated in accordance with the present invention.

### DETAILED DESCRIPTION OF THE INVENTION

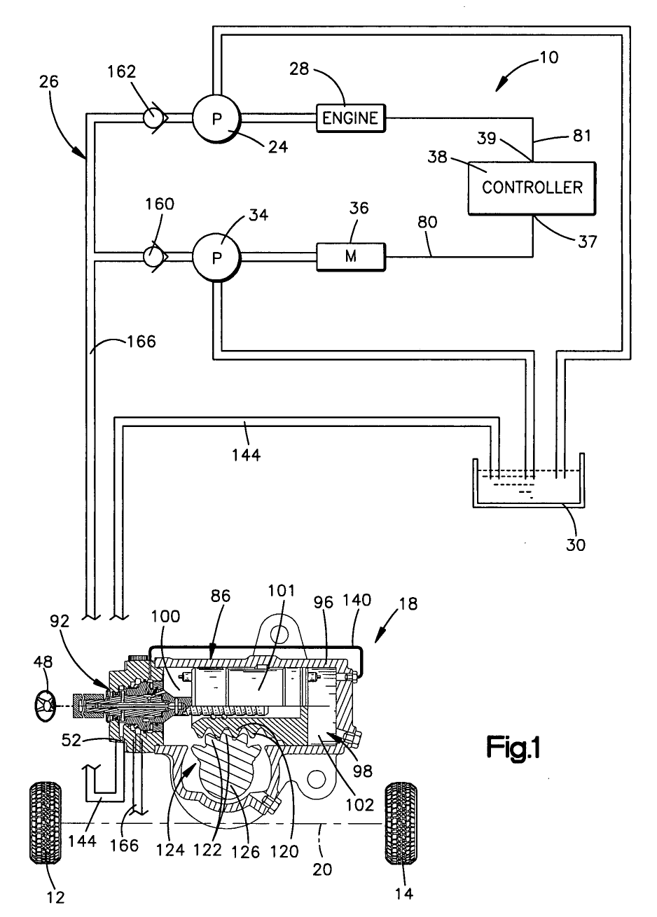

A power steering apparatus 10 (FIG. 1) is used to turn steerable vehicle wheels 12 and 14. The power steering apparatus 10 includes a power steering motor assembly 18. The power steering motor assembly 18 is connected with the steerable vehicle wheels 12 and 14 by a steering linkage 20.

A first pump 24 is connected in fluid communication with the power steering motor assembly 18 by a conduit assembly 26. The first pump 24 is driven by an engine 28 of a vehicle so that the flow rate of the first pump is proportional to the engine speed. The first pump 24 can alternatively be driven by the transmission of the vehicle. The first pump 24 is supplied with hydraulic fluid from a reservoir 30. Fluid exhausted from the power steering motor assembly 18 is returned to the reservoir 30.

A second pump 34 is also connected in fluid communication with the power steering motor assembly 18 and the reservoir 30 by the conduit assembly 26. The first and second pumps 24 and 34 are connected in parallel fluid communication with the power steering motor assembly 18.

A check valve 160 is fluidly connected at the output of the second pump 24 and is effective to block fluid flow from the first pump 24 to the second pump 34. Another check valve 162 is fluidly connected at the output of the first pump 24 and is effective to block fluid flow from the second pump 34 to the first pump 24. A conduit 166 is fluidly connected to the output of each of the check valves 160, 162 and receives the combined flow of fluid from the first and second pumps 24, 34. The conduit 166 is also fluidly connected to the power steering motor assembly 18 to direct the combined flow of fluid to the power steering motor assembly 18.

The second pump 34 is driven by a variable speed electric motor 36. The motor 36 is electrically coupled to an output 37 of a controller 38 by an electrical conductor 80. The operating speed of the electric motor 36 is controlled by the controller 38.

The controller 38 is also electrically connected by an electrical conductor 81 at its input 39 to the engine 28. The controller 38 senses the speed of the engine 28. Alternatively, an engine speed sensor can be electrically coupled between the controller and engine for outputting a signal to the controller indicative of the engine speed.

The controller 38 is operable to vary the operating speed of the electric motor 36 as a function of variation in the engine speed. In particular, the controller 38 is programmed to continuously compare the sensed engine speed signal to stored reference values. The reference values may take the form of look-up tables stored in the memory of the controller 38. When the comparison indicates that the sensed engine speed corresponds to a predetermined stored reference value, the controller 38 outputs a control signal to the motor 36. The control signal drives the motor 36 at a speed that causes the pump 34 to output fluid at a flow rate that maintains the combined flow rate from the first and second pumps at a predetermined value. This predetermined value may be the same for all engine speeds and is also at a value that supplies sufficient hydraulic fluid to operate the power steering motor assembly 18.

The power steering motor assembly 18 includes a power steering motor 86. The power steering motor 86 is connected in fluid communication with the pumps 24 and 34 and with the reservoir 30 by the conduit assembly 26.

A power steering control valve 92 is provided to control fluid flow to and from the power steering motor 86. The power steering control valve 92 is connected with the hand wheel 48. The power steering control valve 92 is operated in response to rotation of the hand wheel 48 to direct fluid flow to the power steering motor 86. Operation of the power steering motor 86 actuates the steering linkage 20 to effect turning movement of the steerable vehicle wheels 12 and 14 under the influence of force transmitted from the power steering motors to the steering linkage.

The power steering motor 86 includes a housing 96 having a chamber 98 in which a generally cylindrical piston 101 is disposed. The piston 101 is effective to divide the chamber 98 into a rod end portion 100 and a head end portion 102. The piston 101 is axially movable in the chamber 98 to vary the size of the rod end and head end portions 100 and 102 of the chamber 98.

Movement of the piston 101 in the housing 96 is effective to actuate the steering linkage 20. The piston 101 is connected to the steering linkage 20 through a linear array of rack teeth 120. The rack teeth 120 are disposed in meshing engagement with an arcuate array of pinion teeth 122. The pinion teeth 122 form part of a sector gear 124. The sector gear 124 is connected with an output shaft 126.

During operation of the power steering motor assembly 18, the piston 101 is moved under the influence of hydraulic fluid conducted from the first pump 24 or from both the first pump 24 and the second pump 34. Upon rotation of the hand wheel 48 to actuate the power steering control valve 92 in one direction, the fluid pressure in the head end portion 102 of the chamber 98 of the power steering motor 86 increases. In addition, the fluid pressure in the rod end portion 100 of the chamber 98 is exhausted to the reservoir 30.

This results in the piston 101 moving toward the left (as viewed in FIG. 1). As the piston 101 moves toward the left, the sector gear 124 is rotated in a counterclockwise direction (as viewed in FIG. 1) to actuate the steering linkage 20. Actuation of the steering linkage 20 is effective to turn the steerable vehicle wheels 12 and 14 in a first direction in a known manner.

Similarly, upon rotation of the hand wheel 48 in the opposite direction, the power steering valve 92 is actuated. Actuation of the power steering valve 92 is effective to direct high fluid pressure into the rod end portion 100 of the chamber 98 in the power steering motor 86 and to exhaust the head end portion 102 of the chamber 98 to the reservoir 30.

This results in the piston 101 in the power steering motor 86 moving toward the right (as viewed in FIG. 1). As this occurs, the sector gear 124 is rotated in a clockwise direction to actuate steering linkage 20. Actuation of the steering linkage 20 is effective to turn the steerable vehicle wheels in a second direction.

Upon actuation of the power steering control valve 92 in response to the rotation of the hand wheel 48 in a first direction, the power steering control valve 92 is effective to direct high fluid pressure to a conduit 140 in the power steering motor assembly 18.

The left (as viewed in FIG. 1) end portion of the conduit 140 is connected with the power steering control valve 92. The right (as viewed in FIG. 1) end portion of the conduit 140 is connected with the head end portion 102 of the chamber 98 in the power steering motor 86.

Rotation of the hand wheel 48 in the first direction is effective to actuate the power steering control valve 92. Actuation of the power steering control valve 92 directs high fluid pressure to the conduit 140. The conduit 140 conducts the same high fluid pressure to the head end portion 102 of the chamber 98 in the power steering motor 86.

When the power steering control valve 92 is actuated to direct high fluid pressure to the conduit 140, the control valve 92 is also effective to connect the rod end portion 100 of the chamber 98 in the power steering motor 86 in fluid communication with the reservoir 30 through a conduit 144 in the conduit assembly 26. The rod end portion 100 of the chamber 98 is connected in fluid communication with the conduit 144 and the reservoir 30 through the actuated power steering control valve 92. Therefore, hydraulic fluid is exhausted from the power steering motor 86 through the power steering control valve 92 to the conduit 144 via return 52 and then to the reservoir 30 during operation of the power steering motor 86 in a first direction.

Similarly, when the hand wheel 48 is turned in the second or opposite direction, the power steering control valve 92 is effective to direct high pressure fluid to the rod end portion 100 of the chamber 98 in the power steering motor 86. At the same time, the power steering control valve 92 is effective to connect the head end portion 102 of the chamber 98 in the power steering motor 86 with the drain conduit 144.

The general construction of the power steering control valve 92 is well known. The. power steering control valve 92 may have the same construction as is disclosed in U.S. Pat. No. 6,546,322. Of course, the power steering control valve 92 may have a different construction if desired.

It is contemplated that the power steering motor assembly 18 may have a construction which is different from the illustrated construction. For example, the power steering motor 86 may be of the general type which is used with a rack and pinion steering gear rather than an integral steering gear.

In operation, the engine 28 drives the first pump 24 to output fluid at a flow rate proportional to the engine speed. The controller 38 outputs a control signal to drive the motor 36 of the second pump 34 at an operating speed which is a function of the speed of the engine 28. The controller 38 controls the second pump 34 so that the combined flow rate of the first and second pumps 24, 34 is at the predetermined value, irrespective of the change in engine speed. Thus, as the flow rate from the first pump 24 decreases due to decreasing engine speed, the controller 38 controls the motor 36 to increase the operating speed of the motor 36 so that the flow rate from the second pump 34 increases. When the flow rate from the first pump 24 increases, the controller 38 controls the motor 36 to decrease the operating speed of the motor 36 so that the flow rate from the second pump 34 decreases.

The combined flow of hydraulic fluid from the first and second pumps 24, 34 is supplied to the power steering motor assembly 18 to operate the power steering motor assembly 18. The combined flow from the first and second pumps 24, 34 is generally constant. The steering effort felt by an operator of the vehicle is generally constant at all engine speeds, since the flow rate to the power steering motor assembly 18 is generally constant.

The flow from the first pump 34 is sufficient to supply most of the hydraulic fluid to the power steering motor assembly 18 during operation of the vehicle at highway or intermediate operating speeds. The second pump 34 supplies most of the hydraulic fluid to the power steering motor assembly 18 during engine idle or at very low engine speeds.

Thus, the power steering apparatus 10 does not require a control valve at the output of the first pump 24 to control the flow rate from the first pump. The second pump 34 varies its flow rate to cause the combined flow rate of the first pump 24 and second pump 34 to be generally constant during all engine speeds. The first pump 24 is optimally sized to supply fluid with minimal parasitic pressure drop, and thus, it can efficiently supply fluid to the power steering motor assembly.

From the above description of the invention, those skilled in the art will perceive improvements, changes and modifications. Such improvements, changes and modifications are intended to be covered by the appended claims.

Having described the invention, the following is claimed:

1. An apparatus for use in turning steerable vehicle wheels, said apparatus comprising:
a power steering motor assembly connected with the steerable vehicle wheels;
a first pump which is connected with said power steering motor assembly and is driven by an engine of the vehicle to supply fluid under pressure to said power steering motor assembly; and
a second pump which is connected with said power steering motor assembly to supply fluid under pressure to said power steering motor assembly at a flow rate that increases as the speed of the engine decreases.

2. The apparatus as set forth in claim 1 wherein said power steering motor assembly includes a power steering motor which is connected with the steerable vehicle wheels, said power steering motor being operable to effect turning movement of the steerable vehicle wheels under the influence of fluid supplied by said first pump until said second pump operates to supply fluid to said power steering motor, said power steering motor being operable to effect turning movement of the steerable vehicle wheels under the influence of fluid supplied by said first and second pumps when said second pump is operated.

3. The apparatus as set forth in claim 1 wherein said second pump supplies fluid to said power steering motor such that the combined flow rate of fluid flowing from said first and second pumps is constant over at least a predetermined range of speeds of said engine.

4. The apparatus as set forth in claim 1 wherein said power steering motor assembly is connected with a control valve which is operable in response to rotation of a hand wheel to direct fluid flow to said power steering motor assembly to effect turning movement of the steerable vehicle wheels under the influence of force transmitted from said power steering motor assembly.

5. An apparatus as set forth in claim 1 wherein said power steering motor assembly includes a piston which is movable under the influence of fluid pressure, rack teeth being connected with said piston and being disposed in meshing engagement with output gear teeth connected with a steering linkage that is connected with the steerable vehicle wheels.

6. The apparatus as set forth in claim 1 wherein said first pump is free of a control valve for controlling the flow rate of the fluid from said first pump.

7. An apparatus for use in turning steerable vehicle wheels, said apparatus comprising:
a power steering motor assembly connected with the steerable vehicle wheels;
a first pump which is connected with said power steering motor assembly and is driven by an engine of the vehicle to supply fluid under pressure to said power steering motor assembly;
a second pump which is connected with said power steering motor assembly;
an electric motor which is connected with said second pump and is operable to drive said second pump to supply fluid under pressure to said power steering motor assembly; and
a controller operatively connected with said electric motor of said second pump to effect operation of said electric motor to drive said second pump to supply fluid at a flow rate based on the speed of said engine.

8. The apparatus as set forth in claim 7 wherein said power steering motor assembly includes a power steering motor which is connected with the steerable vehicle wheels, said power steering motor being operable to effect turning movement of the steerable vehicle wheels under the influence of fluid supplied by said first pump until said control apparatus effects operation of said electric motor to drive said second pump, said power steering motor being operable to effect turning movement of the steerable vehicle wheels under the influence of fluid supplied by said first and second pumps when said electric motor is operated to drive said second pump.

9. The apparatus as set forth in claim 7 wherein said electric motor has an operating speed that varies inversely with the speed of said engine.

10. The apparatus as set forth in claim 7 wherein said controller operates said electric motor such that the combined flow rate of fluid flowing from said first and second pumps is constant over at least a predetermined range of speeds of said engine.

11. The apparatus as set forth in claim 7 wherein said power steering motor assembly is connected with a control valve which is operable in response to rotation of a hand wheel to direct fluid flow to said power steering motor assembly to effect turning movement of the steerable vehicle wheels under the influence of force transmitted from said power steering motor assembly.

12. An apparatus as set forth in claim 7 wherein said power steering motor assembly includes a piston which is movable under the influence of fluid pressure, rack teeth being connected with said piston and being disposed in meshing engagement with output gear teeth connected with a steering linkage that is connected with the steerable vehicle wheels.

13. The apparatus as set forth in claim 7 wherein said first pump is free of a control valve for controlling the flow rate of the fluid from said first pump.
